(19) United States
(12) Patent Application Publication
(10) Pub. No.: US 2025/0135977 A1
(43) Pub. Date: May 1, 2025

(54) MOTOR VEHICLE DOOR ARMREST WIRELESS CHARGING ASSEMBLY

(71) Applicant: GM Global Technology Operations LLC, Detroit, MI (US)

(72) Inventors: Minsu Lee, Gyeonggi-do (KR); Jongseong Choi, Incheon (KR); Dongwon Kim, Incheon (KR); Heewon Lee, Seoul (KR)

(73) Assignee: GM Global Technology Operations LLC, Detroit, MI (US)

(21) Appl. No.: 18/497,283

(22) Filed: Oct. 30, 2023

(51) Int. Cl. B60N 2/75; H02J 7/00

(52) U.S. Cl. CPC B60N 2/79; H02J 7/0047; H02J 7/007188

(57) ABSTRACT

A charging system for a passenger door includes an arm rest, a receptacle disposed in the arm rest and defining a pocket including a charging panel configured to provide wireless charging to an electronic device, a charging system actuator configured to selectively bias the electronic device against the charging panel and including an electronic device presence sensor, and a charging system controller in communication with the electronic device presence sensor. The charging system controller is configured to execute operations including receiving an electronic device presence signal from the electronic device presence sensor, determining whether the electronic device is disposed within the receptacle based on the electronic device presence signal, and instructing the charging system to generate a notification signal when the electronic device is disposed within the receptacle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a wireless charging device that is incorporated into the armrest of an interior door panel of a motor vehicle, and more specifically, a charging device mounted in a vertical orientation that is included within a pocket of an armrest of the door panel, allowing a portable electronic device to receive a charge while placed in the pocket.

Current wireless charging devices that exist in vehicles are in the form of a charging panel, or charging pad, generally placed somewhere near the center console between the driver seat and the front passenger seat. A smart phone or other electronic device can placed in a horizontal orientation on top of the charging pad and the electronic device begins to charge wirelessly. However, this feature is typically offered in the front row of a vehicle, leaving passengers in the rear of the vehicle without this convenience of wireless charging. Further, horizontal charging solutions may require space within the vehicle passenger compartment that could otherwise be used for passenger occupancy or other functions. In addition, the pockets within the arm rests of interior door panels serve no significant purpose other than providing a passenger with a grip while opening and closing the door, or as a common place for passengers to place small items such as coins, receipts, or pieces of trash.

### SUMMARY

An aspect of the disclosure provides a charging system for a passenger door of a motor vehicle. The charging system includes an arm rest, a receptacle disposed in the arm rest defining a pocket that includes a charging panel configured to provide wireless charging to an electronic device, a charging system actuator configured to selectively bias the electronic device against the charging panel and including an electronic device presence sensor, and a charging system controller in communication with the electronic device presence sensor. The charging system controller includes data processing hardware and memory hardware in communication with the data processing hardware. The memory hardware stores instructions that, when executed on the data processing hardware, cause the data processing hardware to perform operations. These operations include receiving an electronic device presence signal from the electronic device presence sensor, determining whether the electronic device is disposed within the receptacle based on the electronic device presence signal, and instructing the charging system to generate a notification signal when the electronic device is disposed within the receptacle.

Implementations of the disclosure may include one or more of the following optional features. In some examples, the charging system actuator includes a biasing element adjacent to the charging panel and configured to move between a first position to receive an electronic device between the charging system actuator and the charging panel and a second position to bias the electronic device against the charging panel.

In some implementations, the operations include receiving a door state signal associated with a vehicle passenger door including the charging system, determining the vehicle passenger door is open, and instructing the charging system to generate the notification signal when the electronic device is disposed within the receptacle and the passenger door is open.

In some configurations, the electronic device presence sensor includes a ground plate in communication with the charging system controller, where a circuit of the ground plate is closed when the electronic device is within the receptacle and the circuit of the ground plate is open when the electronic device is removed from the receptacle.

In some further implementations, the charging system includes a vehicle passenger door state sensor configured to measure a state of the vehicle passenger door. In some examples, the vehicle passenger door state sensor includes a reed sensor in communication with the charging system controller, the reed sensor being positioned outside the receptacle and configured to move to a closed state when the vehicle passenger door is in a closed state.

In some examples, the operations of the charging system include instructing the charging system to generate the notification signal when the state of the ground plate and the reed sensor changes from both circuits being in the closed state, to the circuit of the reed sensor being in an open state while the circuit of the ground plate remains in the closed state.

In some implementations, the charging system includes a wired charging port positioned adjacent to the pocket.

Another aspect of the disclosure provides a door panel for a motor vehicle. The door panel includes an arm rest and a charging system. The charging system includes a receptacle disposed in the arm rest and defining a pocket including a charging panel configured to provide wireless charging to an electronic device, and a charging system actuator configured to selectively bias the electronic device against the charging panel and including an electronic device presence sensor.

Implementations of this aspect of the disclosure may include one or more of the following optional features. In some examples, the charging system actuator includes a biasing element spaced apart from the charging panel and configured to move between a first position to receive an electronic device between the charging system actuator and the charging panel and a second position to bias the electronic device against the charging panel. In some configurations, the door panel includes an electronic device presence sensor configured to detect the presence of the electronic device within the receptacle.

In some implementations, the door panel includes a charging system controller in communication with the electronic device presence sensor. The charging system controller includes data processing hardware and memory hardware in communication with the data processing hardware. The memory hardware stores instructions that, when executed on the data processing hardware, cause the data processing hardware to perform operations. These operations include receiving an electronic device presence signal from the electronic device presence sensor, determining whether the electronic device is disposed within the receptacle based on the electronic device presence signal, and instructing the charging system to generate a notification signal when the electronic device is disposed within the receptacle.

In some examples, the operations of the door panel further include determining whether a vehicle passenger door associated with the arm rest is open, and instructing the charging system to generate the notification signal when the electronic device is disposed within the receptacle and the vehicle passenger door is open.

In some configurations, the electronic device presence sensor includes a ground plate in communication with the charging system controller and positioned to bias the electronic device placed within the receptacle, where a circuit of the ground plate is closed when the electronic device is within the pocket and the circuit of the ground plate is open when the pocket is vacant.

In implementations, the door panel includes a vehicle passenger door state sensor configured to measure a state of the vehicle passenger door. In some examples, the door panel includes a wired charging port positioned adjacent to the pocket.

An additional aspect of the disclosure provides a motor vehicle. The motor vehicle includes an arm rest and a charging system. The charging system includes a receptacle disposed in the arm rest and defining a pocket including a charging panel configured to provide wireless charging to an electronic device, a charging system actuator configured to selectively bias the electronic device against the charging panel and including an electronic device presence sensor, and a charging system controller in communication with the electronic device presence sensor. The charging system controller includes data processing hardware and memory hardware in communication with the data processing hardware, the memory hardware storing instructions that, when executed on the data processing hardware, cause the data processing hardware to perform operations. These operations include receiving an electronic device presence signal from the electronic device presence sensor, determining whether the electronic device is disposed within the receptacle based on the electronic device presence signal, and instructing the charging system to generate a notification when the electronic device is disposed within the receptacle.

Implementations of this aspect of the disclosure may include one or more of the following optional features. In some examples, the charging system actuator includes a biasing element adjacent to the charging panel and configured to move between a first position to receive an electronic device between the charging system actuator and the charging panel and a second position to bias the electronic device against the charging panel.

In some implementations, the operations of the motor vehicle include determining whether a vehicle passenger door associated with the arm rest is open, and instructing the charging system to emit the notification when the electronic device is disposed within the receptacle and the vehicle passenger door is open.

In some configurations, the motor vehicle includes a wired charging port positioned adjacent to the pocket.

### BRIEF DESCRIPTION OF THE DRAWINGS

The drawings described herein are for illustrative purposes only of selected configurations and are not intended to limit the scope of the present disclosure.

FIG. 1 is a perspective view of an interior portion of a motor vehicle passenger door including an example of a charging system according to the principles of the present disclosure;

FIG. 2 is an enlarged partial perspective view of a receptacle of the charging system of FIG. 1, showing an electronic device placed within the receptacle;

FIG. 3 is a side perspective view of a side of the receptacle of the charging system of FIG. 1;

FIG. 4 is a top plan view of the receptacle of the charging system of FIG. 1, showing a portion of a charging system controller;

FIG. 5 is a rear perspective view of the charging system of FIG. 1, showing a charging system controller installed on an opposite side of a door panel from the receptacle;

FIG. 6A is an enlarged partial perspective view of the charging system of FIG. 1 when an electronic device is not present in the receptacle;

FIG. 6B is schematic view of an electronic device presence sensor of the charging system of FIG. 6A when an electronic device is not present in the receptacle;

FIG. 7A is an enlarged partial perspective view of the charging system of FIG. 1 when an electronic device is present in the receptacle;

FIG. 7B is schematic view of an electronic device presence sensor of the charging system of FIG. 7A when an electronic device is present in the receptacle;

FIG. 8A is a fragmentary perspective view of a vehicle passenger door assembly and vehicle frame associated with the charging system of the present disclosure, showing the motor vehicle passenger door in a closed state with a body striker engaged with a door latch;

FIG. 8B is a schematic view of a door state sensor of the charging system of FIG. 1 in the closed state when the vehicle passenger door is closed;

FIG. 9A is a fragmentary perspective view of the vehicle passenger door state sensor of the charging system of FIG. 1, showing the motor vehicle passenger door in the open state with the body striker disengaged from a door latch;

FIG. 9B is a schematic view of the sensor of the charging system of FIG. 1 in the open position when the vehicle passenger door is open; and

FIG. 10 is a schematic view of the charging system of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The option for wireless charging in vehicles is something that has generally been reserved to the front console area, between the driver and passenger seat. This provides the capability for either the driver or the front seat passenger to conveniently use this feature, however, passengers in the rear seat of the vehicle do not have convenient access to wirelessly charge their electronic device. Additionally, the lack of additional wireless charging panels prevents multiple electronic devices from being wirelessly charged simultaneously. By incorporating a wireless charging pad into a vehicle's interior door panel, all passengers within a vehicle will have a convenient manner of charging their electronic device.

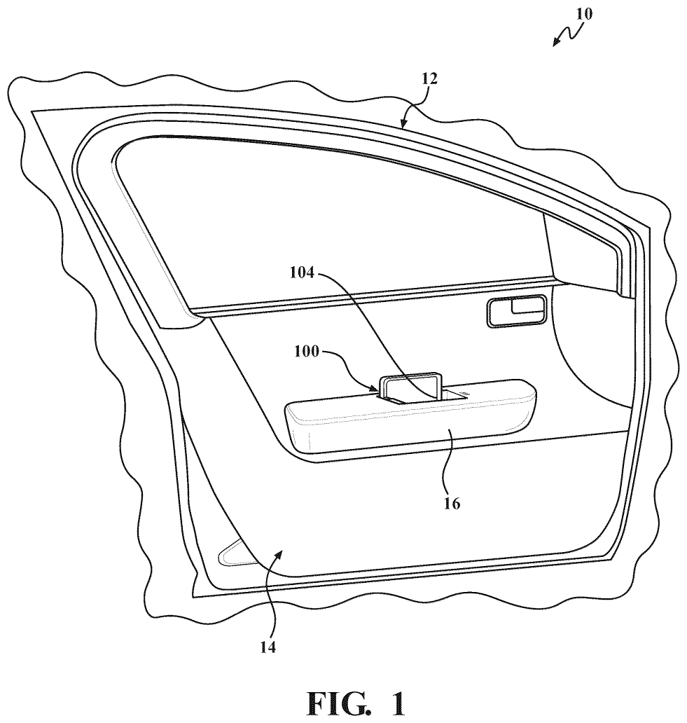

Referring to FIG. 1, an interior environment of a motor vehicle 10 is shown. Particularly, FIG. 1 shows a fragmentary view of an interior compartment of the motor vehicle 10 and includes an example of a passenger door 12 that would be included as part of a vehicle 10. The passenger door 12 includes an interior door panel 14 having an arm rest 16. Incorporated in the interior door panel 14 is a charging system 100 used to wirelessly charge an electronic device 18. As described in greater detail below, the charging system 100 includes a receptacle 102 configured to receive an electronic device 18, which may be placed in the receptacle 102 by the user in order to receive a charge.

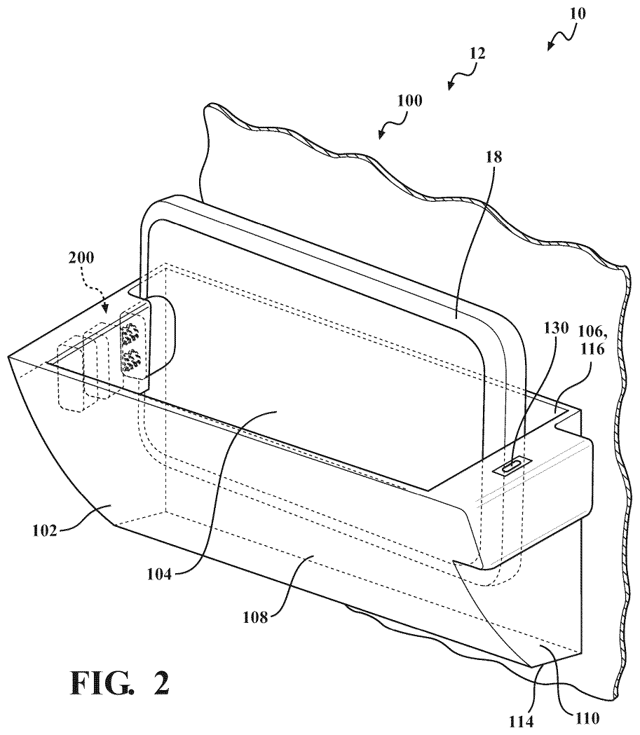

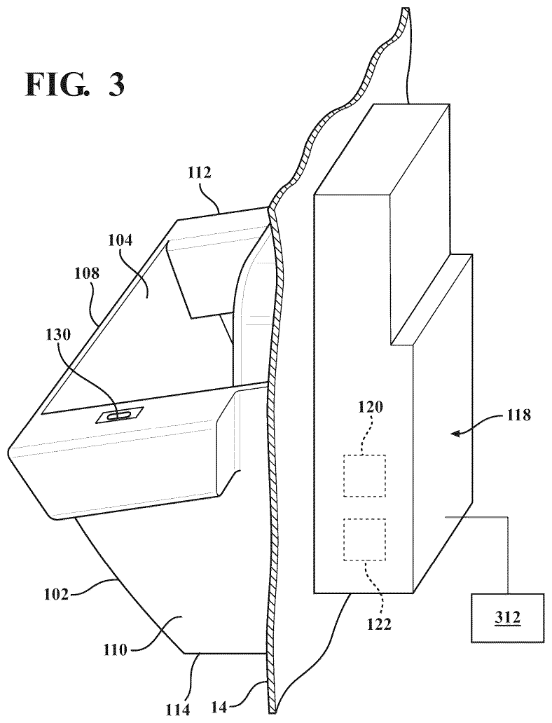

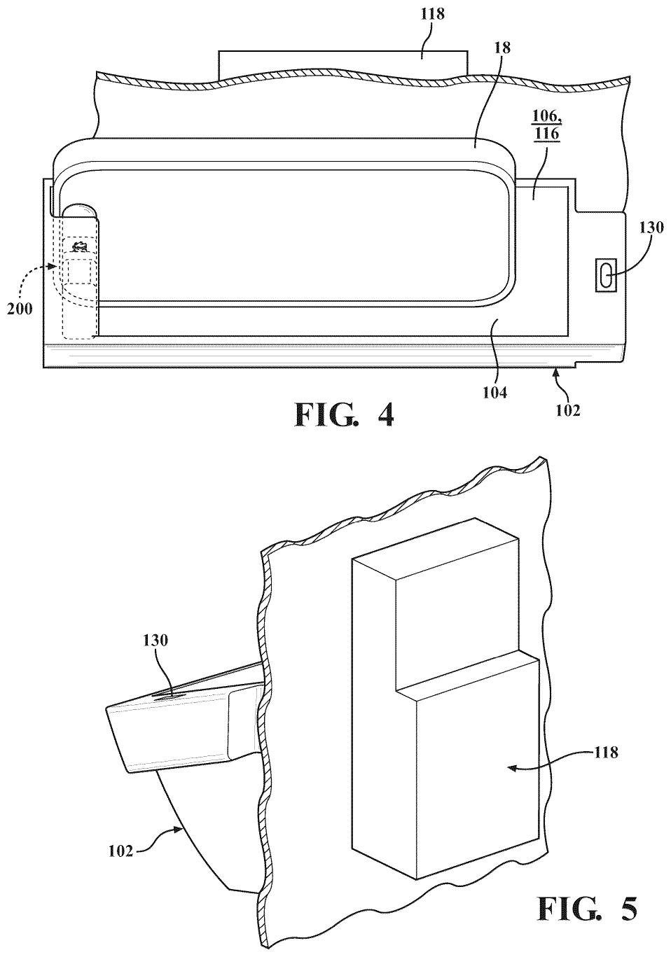

Referring to FIGS. 2-5, enlarged views of elements of the charging system 100 are provided. In the illustrated example, the charging system 100 is illustrated in isolation from the arm rest 16 for clarity. The charging system 100 includes the receptacle 102 attached to an interior portion (i.e., facing the passenger compartment) of the door panel 14 of the door 12. The receptacle 102 generally defines a pocket 104 configured to receive the electronic device 18. As shown, the receptacle includes an outer wall 106, an inner wall 108 spaced apart from the outer wall 106 by the pocket 104, a pair of end walls 110, 112 disposed at opposite ends of the pocket 104, and a bottom wall 114 enclosing a lower portion of the pocket 104 and defining a support surface for receiving the electronic device 18. In the illustrated example, the inner wall 108 of the receptacle 102 is oriented at an oblique angle relative to the outer wall 106, whereby a width of the pocket 104 (i.e., the distance from the outer wall 106 to the inner wall 108) increases along a direction from the bottom wall 114 to an upper opening of the pocket 104.

The outer wall 108 of the receptacle 102 includes or defines a charging panel 116 configured to provide a wireless charging interface for the electronic device 18. For example, the wireless charging panel 116 may be incorporated in a vertical orientation, whereby the electronic device 18 can be placed near the wireless charging panel 116 in order for the electronic device 18 to receive a wireless charge. In other words, when a wireless charging zone of the electronic device 18 is placed adjacent to the wireless charging panel 116, the electronic device 18 will be charged wirelessly. In order to keep the electronic device 18 biased against the wireless charging panel 116, a charging system actuator 200 is provided on the receptacle 102.

The charging system 100 further includes a charging system controller 118 associated with the wireless charging panel 116 at the outer wall 106 of the receptacle 102. When the charging system 100 is incorporated into a door panel 12 of the vehicle 10, the charging system controller 118 may be incorporated on an opposite side of the door panel 14 from the receptacle 102, whereby the charting system controller 118 is hidden from the user within the door 12. The charging system controller 118 includes or communicates with data processing hardware 120 and memory hardware 122 for storing and executing instructions for operating the charging system 100. Further, the charging system controller 118 receives power (e.g., voltage) from a power system of the vehicle 10 and selectively controls provision of the power to the wireless charging panel 116. When the charging system controller 118 receives power, it is configured to selectively provide the power to the wireless charging panel 116 to charge an electronic device 18 when the electronic device 18 is placed against the wireless charging panel 116.

Additionally, the charging system controller 118 may optionally send power to a wired charging port 130 (e.g., a USB connection) disposed adjacent to the pocket 104 of the receptacle 102. In the illustrated example, the wired charging port is integrated into the front end wall 110 of the receptacle 102, adjacent to the pocket 104. Thus, the wired charging port 130 of the illustrated example is positioned in a manner to be accessible even when an electronic device 18 is contained and charging in the receptacle 102. Therefore, two electronic devices could be simultaneously charged using the charging system 100.

The wireless charging panel 116 is configured to charge an electronic device 18 regardless of whether the electronic device 18 is placed in a horizontal or vertical orientation, as long as the charging zone, typically integrated in a rear panel of the electronic device 18, is placed adjacent to the wireless charging panel 116. In some examples, the wireless charging panel 116 is configured such that the electronic device 18 will charge in any orientation when the electronic device 18 is positioned between the wireless charging panel 116 and the charging system actuator 200. This flexibility in the orientation of the electronic device 18 allows for the charging system 100 to accommodate a greater variety of electronic devices 18, such as smart phones and tablets.

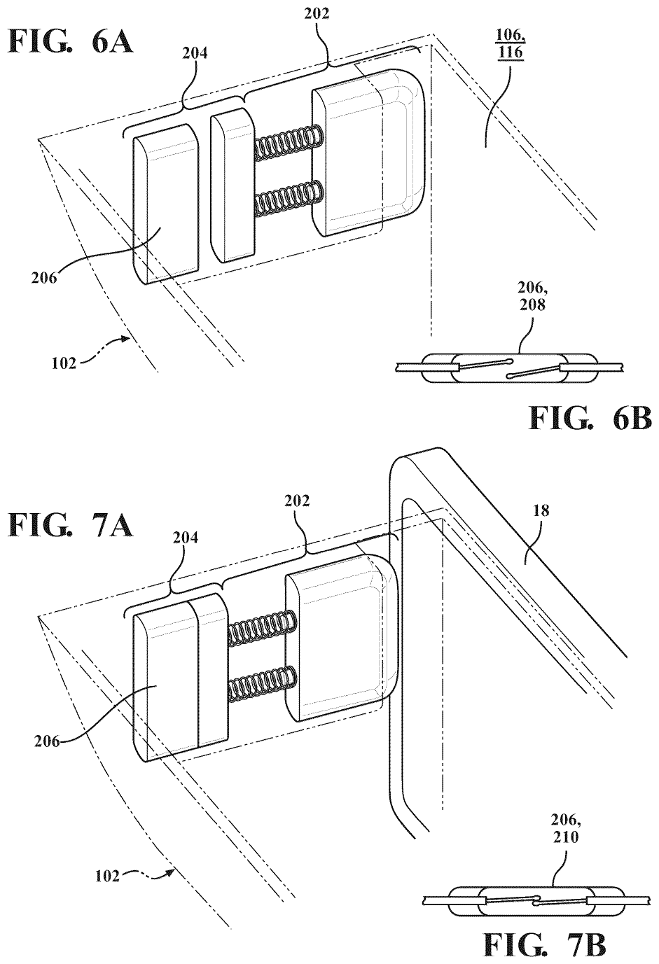

Referring to FIGS. 6A-9B, the charging system actuator 200 and a passenger door state sensor 300 are shown in detail. The charging system actuator 200 includes a biasing element 202 configured to bias the electronic device 18 against the wireless charging panel 116 to maintain the electronic device 18 in a charging position. When the user places an electronic device 18 in the pocket 104 of the receptacle 102, the electronic device 18 is received between the biasing element 202 and the wireless charging panel 116. In the illustrated example, the biasing element 202 incorporates one or more springs that bias the electronic device 18 against the wireless charging panel 116. Because the electronic device 18 is oriented in an upright orientation within the pocket 104 when receiving a charge, the biasing element 202 provides the benefit of maintaining force against the electronic device 18 to maintain the electronic device 18 against the wireless charging panel 116, which maintains the electronic device 18 in a charging state.

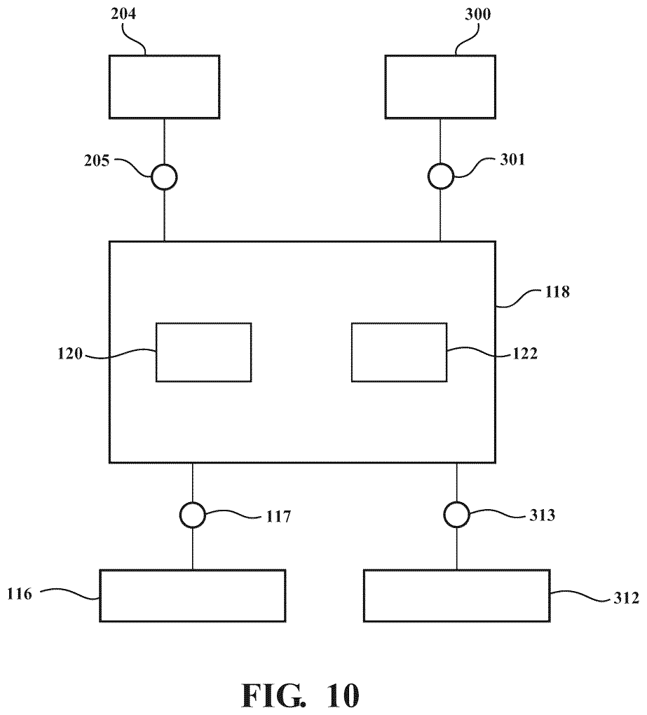

The charging system actuator 200 further includes an electronic device presence sensor 204, which monitors the status of the receptacle 102 to determine if an electronic device 18 is present in the receptacle 102. In the illustrated example, the electronic device presence sensor 204 includes a ground plate assembly 206. If an electronic device 18 is not present in the pocket 204, which is represented in FIG. 6A, the ground plate 206 of the electronic device presence sensor 204 is disconnected, creating an open circuit 208 (FIG. 6B) in the electronic device presence sensor 204. However, when an electronic device 18 is present in the receptacle 102, which is represented in FIG. 7A, the ground plate 206 of the electronic device presence sensor 204 becomes connected, closing the circuit 210 (FIG. 7B) in the electronic device presence sensor 204. The electronic device presence sensor 204 is configured to communicate an electronic device presence signal 205 (FIG. 10) to the charging system controller 118 to indicate whether or not an electronic device 18 is present in the pocket 104. When the electronic device presence signal 205 indicates that that an electronic device 18 is present in the pocket 104, the charging system controller 118 sends a charging signal 117 to the charging panel 116 to provide wireless charging. While the present disclosure illustrates the electronic device presence sensor 204 as a ground plate, other types of presence sensors may be incorporated into the charging system 100 to detect the presence of the electronic device 18. For example, vision sensors or capacitive sensors may be integrated into the receptacle 102 to determine when an electronic device is received within the pocket 104.

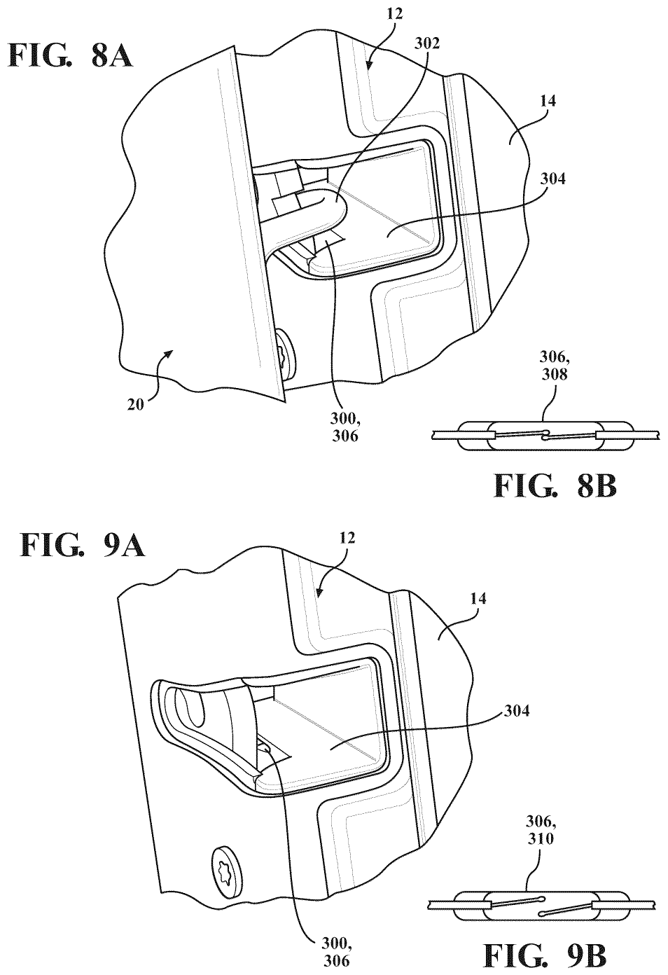

Optionally, the electronic device presence sensor 204 may operate in coordination with a vehicle passenger door state sensor 300 and the charging system controller 118 to provide a notification to a passenger when an electronic device 18 is contained in the receptacle 102 and the vehicle passenger door 12 is opened. With reference to FIGS. 8A-9B, in one example of a door state sensor 204, the vehicle passenger door 12 includes a body striker 302 associated with a vehicle passenger door frame 20 and a corresponding door latch 304 associated with the vehicle passenger door 12. The door state sensor 300 may be incorporated in the door latch 304 or the door striker 302 and is generally configured to measure a state of the door 12 and to communicate a door state signal 301 (FIG. 10) to the charging system controller 118 and/or a central vehicle controller (not shown). When the body striker 302 is engaged with the door latch 304 of a vehicle passenger door, the door state sensor 300 (shown as a reed sensor in FIG. 8B and FIG. 9B) provides a closed circuit 308, indicating that the door 12 is closed. Alternatively, when the vehicle passenger door 12 is open, the door latch 304 is vacant because the body striker 302 is not present, meaning the door state sensor 300 will provide an open circuit 310. In use, the charging system actuator 200 and the door state sensor 300 cooperate with the charging system controller 118 and/or a central vehicle controller to notify the user if an electronic device 18 is present in the receptacle 102 when the user is opening the door 12 to exit the vehicle 10.

Example operation of the vehicle charging system 100 and the sensors 204, 300 to provide the notification are now described relative to the schematic shown in FIGS. 6A-10. Before a user enters a vehicle 10, the door 12 of the vehicle 10 is closed, meaning the reed sensor 306 in the door latch 304 is closed and connected because the door latch 304 is in contact with the body striker 302. Additionally, no electronic device 18 is present in the receptacle 102, meaning the circuit of the ground plate 206 in the electronic device presence sensor 204 is disconnected and open. When the user opens the door to enter the vehicle 10, the reed sensor 306 moves to the open state and the door state sensor 300 transmits a corresponding door state signal 301 to the charging system controller 318. Once the user is inside the vehicle 10 and the door 12 is closed, the circuit of the reed sensor 306 is once again closed when the door latch 304 is engaged with the body striker 302. If the user desires to use the charging system 100 on the door panel 12 to wirelessly charge an electronic device 18, the electronic device 18 is placed in the receptacle 102. By doing so, the ground plate 206 of the electronic device presence sensor 204 will be connected, completing and closing the circuit, and the electronic device presence sensor 204 sends a corresponding electronic device presence sensor signal 205 to the charging system controller 218. Thus, in the first step, both the reed sensor 306 circuit is closed and the circuit in the electronic device presence sensor 204 is closed. If the user wants to exit the vehicle, for example, after the drive is complete, the audible notification will occur if the user opens the door 12 while keeping the electronic device 18 in the receptacle 102. By doing so, the reed sensor 306 in the door latch 304 will be in an open state and disconnected, while the circuit of the electronic device presence sensor 204 remains closed because the electronic device 18 was never removed from the receptacle 102.

With reference to FIG. 10, the communication that occurs between the electronic device presence sensor 204, the door sensor 300, and the charging system controller 118 is schematically shown. When the charging system controller 118 determines that the door 12 is in an open state (i.e., the circuit of the door state sensor 300 is open) and the electronic device 18 is present in the receptacle 102 (i.e., the circuit of the electronic device presence sensor 204 is closed), the charging system controller 118 transmits a notification signal 313 to a notification device 312 of the vehicle 10. For example, the notification device 312 may be a speaker that generates an audible notification and/or a display that generates a visual notification. This notification will occur until the status of the reed sensor 306 circuit or the status of the electronic device presence sensor 204 circuit is changed. In other words, once the user removes the electronic device 18 from the receptacle 102 or closes the door 12, the notification will cease. This notification is to remind the user to remove the electronic device 18 from the receptacle 102 if the vehicle passenger door 12 is opened. Not only is this to prevent scenarios where the user may have forgotten to retrieve the electronic device 18 from the receptacle 102 when the user is leaving the vehicle 10, but it is also to prevent the vehicle passenger door 12 from being closed while an electronic device 18 is still contained within the receptacle 102, thereby protecting the electronic device 18 from the impact of a vehicle passenger door 12 closing.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A charging system for a passenger door of a motor vehicle, the charging system comprising:
an arm rest;
a receptacle disposed in the arm rest and defining a pocket including a charging panel configured to provide wireless charging to an electronic device;
a charging system actuator configured to selectively bias the electronic device against the charging panel and including an electronic device presence sensor; and
a charging system controller in communication with the electronic device presence sensor, the charging system controller including data processing hardware and memory hardware in communication with the data processing hardware, the memory hardware storing instructions that, when executed on the data processing hardware, cause the data processing hardware to perform operations comprising:
receiving an electronic device presence signal from the electronic device presence sensor;
determining whether the electronic device is disposed within the receptacle based on the electronic device presence signal; and
instructing the charging system to generate a notification signal when the electronic device is disposed within the receptacle.

2. The charging system of claim 1, wherein the charging system actuator includes a biasing element adjacent to the charging panel and configured to move between a first position to receive an electronic device between the charging system actuator and the charging panel and a second-position to bias the electronic device against the charging panel.

3. The charging system of claim 1, wherein the operations further comprise:
receiving a door state signal associated with a vehicle passenger door including the charging system;
determining the vehicle passenger door is open; and
instructing the charging system to generate the notification signal when the electronic device is disposed within the receptacle and the passenger door is open.

4. The charging system of claim 1, wherein electronic device presence sensor includes a ground plate in communication with the charging system controller, where a circuit of the ground plate is closed when the electronic device is within the receptacle and the circuit of the ground plate is open when the electronic device is removed from the receptacle.

5. The charging system of claim 4, further comprising a vehicle passenger door state sensor configured to measure a state of the vehicle passenger door.

6. The charging system of claim 5, wherein the vehicle passenger door state sensor includes a reed sensor in communication with the charging system controller, the reed sensor being positioned outside the receptacle and configured to move to a closed state when the vehicle passenger door is in a closed state.

7. The charging system of claim 6, wherein the operations further comprise instructing the charging system to generate the notification signal when the state of the ground plate and the reed sensor changes from both circuits being in the closed state, to the circuit of the reed sensor being in an open state while the circuit of the ground plate remains in the closed state.

8. The charging system of claim 1, further comprising a wired charging port positioned adjacent to the pocket.

9. A door panel for a motor vehicle, the door panel comprising:
an arm rest;
a charging system including:
a receptacle disposed in the arm rest and defining a pocket including a charging panel configured to provide wireless charging to an electronic device; and
a charging system actuator configured to selectively bias the electronic device against the charging panel and including an electronic device presence sensor.

10. The door panel of claim 9, wherein the charging system actuator includes a biasing element spaced apart from the charging panel and configured to move between a first position to receive an electronic device between the charging system actuator and the charging panel and a second-position to bias the electronic device against the charging panel.

11. The door panel of claim 10, further comprising an electronic device presence sensor configured to detect the presence of the electronic device within the receptacle.

12. The door panel of claim 11, further comprising a charging system controller in communication with the electronic device presence sensor, the charging system controller including data processing hardware and memory hardware in communication with the data processing hardware, the memory hardware storing instructions that, when executed on the data processing hardware, cause the data processing hardware to perform operations comprising:
receiving an electronic device presence signal from the electronic device presence sensor;
determining whether the electronic device is disposed within the receptacle based on the electronic device presence signal; and
instructing the charging system to generate a notification signal when the electronic device is disposed within the receptacle.

13. The door panel of claim 12, wherein the operations further comprise:
determining whether a vehicle passenger door associated with the arm rest is open; and
instructing the charging system to generate the notification signal when the electronic device is disposed within the receptacle and the vehicle passenger door is open.

14. The door panel of claim 12, wherein the electronic device presence sensor includes a ground plate in communication with the charging system controller and positioned to bias the electronic device placed within the receptacle, where a circuit of the ground plate is closed when the electronic device is within the pocket and the circuit of the ground plate is open when the pocket is vacant.

15. The door panel of claim 12, further comprising a vehicle passenger door state sensor configured to measure a state of the vehicle passenger door.

16. The door panel of claim 9, further comprising a wired charging port positioned adjacent to the pocket.

17. A motor vehicle comprising:
an arm rest; and
a charging system having:
a receptacle disposed in the arm rest and defining a pocket including a charging panel configured to provide wireless charging to an electronic device;
a charging system actuator configured to selectively bias the electronic device against the charging panel and including an electronic device presence sensor; and
a charging system controller in communication with the electronic device presence sensor, the charging system controller including data processing hardware and memory hardware in communication with the data processing hardware, the memory hardware storing instructions that, when executed on the data processing hardware, cause the data processing hardware to perform operations comprising:
receiving an electronic device presence signal from the electronic device presence sensor;
determining whether the electronic device is disposed within the receptacle based on the electronic device presence signal; and
instructing the charging system to generate a notification when the electronic device is disposed within the receptacle.

18. The motor vehicle of claim 17, wherein the charging system actuator includes a biasing element adjacent to the charging panel and configured to move between a first position to receive an electronic device between the charging system actuator and the charging panel and a second-position to bias the electronic device against the charging panel.

19. The motor vehicle of claim 17, wherein the operations further comprise:
determining whether a vehicle passenger door associated with the arm rest is open; and
instructing the charging system to emit the notification when the electronic device is disposed within the receptacle and the vehicle passenger door is open.

20. The motor vehicle claim 17, further comprising a wired charging port positioned adjacent to the pocket.
